(19) United States
(12) Patent Application Publication
(10) Pub. No.: US 2006/0034752 A1
(43) Pub. Date: Feb. 16, 2006

(54) Visible-light-activated photocatalyst and method for producing the same

(75) Inventors: Yu-Ming Lin, Hsinchu County (TW); Yao-Hsuan Tseng, Taoyuan County (TW); Chien-Chih Chen, Taichung County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 10/969,943

(22) Filed: Oct. 22, 2004

(30) Foreign Application Priority Data
Jun. 30, 2004 (TW) 93119445

(51) Int. Cl. C01G 23/047

(52) U.S. Cl. 423/610; 502/339

(57) ABSTRACT

A visible-light-activated photocatalyst powder and method for producing and modifying the same are provided. The visible-light-activated photocatalyst powder is produced by improving the process conditions or by modifying with platinum oxide. Further, the UV light-activated titanium dioxide is modified to be more visible light activated by loading platinum oxide on the surface of titanium dioxide. The methods enhance the conversion of sunlight irradiation to chemical energy. The air-born pollutants can be degraded by the treatment with the photocatalyst under UV or visible light irradiation.

### BACKGROUND OF THE INVENTION

1. Field of the Invention

The present invention relates to a visible-light-activated photocatalyst and method for producing the same. The visible-light-activated titanium dioxide photocatalyst is produced by controlling the process conditions or modifying with platinum oxide to give the titanium dioxide photocatalytic activity under visible light irradiation.

2. Description of the Related Art

Nanomaterials are materials with size ranging from 1 nm to 100 nm. Given their tiny dimensions, nanomaterials exhibit many properties, for example, electrical, thermal, magnetic and optical properties, different from those of larger sized materials. Nanotechnology is a technology for preparing a nanomaterial using direct or indirect methods to manipulate atoms or molecules, and applying the nanomaterial in various fields. Nanomaterials come in a wide variety and cover the fields of semiconductor, metal, polymer, biomedicine, carbon tube, etc. Nanomaterials are typically measured by their electrical, optical, magnetic, thermal and chemical properties. The novel characteristics of nanomaterials are also applicable to industrial catalyst to enhance the surface area of the catalyst. The doping of nanomaterial can also be used to enhance the mechanical strength of devices. Turning semiconductor materials into nanosize can create high quantum confinement of electron and hole to increase the illumination efficiency and breakdown temperature of semiconductor laser. The availability of nanosized semiconductor can further reduce the size of optical and electrical components. Nanotechnology will make the integration of electronic, optical, magnetic and bio components possible.

Titanium dioxide (titania) nanoparticles as photocatalyst have been extensively used to improve our living environment and gradually accepted by the consumer public. Titanium dioxide photocatalyst possesses anatase crystalline phase with grain size under 30 nm. Under ultraviolet light irradiation (wavelength under 388 nm), active species are produced on the surface of titanium dioxide particle which can oxidize or reduce the pollutants. In addition, because oxygen atoms are detached from the surface, the photocatalyst becomes highly hydrophilic, thus possessing anti-fog, anti-dust and other self-cleaning functions. Titanium dioxide photocatalyst has been used extensively for pollutant removal, air cleansing, water purification, odor removal, anti-septic, anti-dust and anti-fog purposes. Doped photocatalyst with light source from fiber optic is found to inhibit the growth of cancer cells or even kill cancer cells.

Titanium dioxide semiconductor has an energy bandwidth of approximately 3.2 eV, which corresponds to a wavelength of 388 nm. But constrained by the energy level, the wavelength of light required to activate the titanium photocatalyst must be less than 388 nm, which is near UV radiation. In the light spectrum of solar energy, UV light accounts for a small section, about 5%. In an indoor environment, the content of UV light in the light source is also low. UV light could cause skin pathology and is harmful to humans. Therefore, visible-light-activated photocatalyst not only renders the use of solar energy more efficient, it can produce the cleansing effect under the harmless visible light range.

Some literatures have mentioned the use of ion-implantation or chemical vapor deposition (CVD) to modify titanium dioxide photocatalyst. But the processes involve expensive equipments. Some articles mentioned other methods for preparing metal-modified photocatalyst. For example, Taizo Sano et al. presented in the Journal of Molecular Catalyst A: Chemical in 2002 a method of depositing Pt and Pd on the surface of photocatalyst (P25) to enhance its selectivity over vinyl chloride. But the article did not mention whether the resulting photocatalyst is visible-light-responsive. Horst Kisch et al. presented in the CHEMPHYSCHEM in 2002, a method of depositing PtCl₄, AuCl₂, and RuCl₃ either in the bulk or only on the surface of photocatalyst to enhance the visible-light-photocatalysis of 4-chlorophenol in an aqueous phase. But the article did not mention whether the resulting photocatalyst is visible-light-responsive in air purification system. Visible-light-activated photocatalyst has high market potential and great economic value. It is a subject worth developing.

### SUMMARY OF THE INVENTION

To address the drawbacks of prior arts about photocatalytic technology, the present invention discloses the preparation of titanium dioxide with anatase and brookite phase under controlled conditions, which can be used as a visible-light-activated photocatalyst. The present invention also modifies titanium dioxide photocatalyst that does not absorb light in the visible spectrum into visible-light-activated photocatalyst by loading platinum oxide on its surface.

The present invention is to provide a method for preparing visible-light-activated titanium dioxide photocatalyst, comprising the steps of: providing a titanium salt; preparing the titanium salt into aqueous solution of alcohol; adding an acid catalyst into the aqueous solution of alcohol to obtain a precipitate; drying the precipitate; and pulverizing and calcining the dried precipitate; wherein the calcination temperature ranges from 150° C. to 400° C., preferably between 150° C. and 250° C.

Additionally, the present invention is to provide a titanium dioxide photocatalyst having a mixed anatase-brookite phase and grain size ranging from 5 to 20 nm which exhibits photocatalytic activity under ultraviolet light irradiation (wavelength <400 nm) and visible light irradiation (wavelength range from 400 nm to 700 nm).

Alternatively, the present invention is to provide a method for preparing visible-light-activated titanium dioxide photocatalyst, comprising the steps of: providing a titanium salt; mixing the titanium salt with aqueous solution of alcohol containing platinum salt; adding an acid catalyst into the aqueous solution of alcohol to obtain a precipitate; drying the precipitate; and pulverizing and calcining the dried precipitate; wherein the calcination temperature ranges from 150° C. to 400° C., preferably between 150° C. and 250° C.

Moreover, the present invention is to provide a titanium dioxide photocatalyst containing platinum oxide and with anatase phase and grain size ranging from 5 to 20 nm which exhibits photocatalytic activity under ultraviolet light irradiation (wavelength <400 nm) and visible light irradiation (wavelength range from 400 nm to 700 nm).

The present invention is to provide a method for preparing visible-light-activated titanium dioxide photocatalyst, comprising the steps of: providing a nanosized titanium dioxide catalyst; adding the titanium dioxide photocatalyst into the aqueous solution of platinum salt and mixing; drying the platinum salt solution; and pulverizing and calcining the dried product; wherein the calcination temperature ranges from 150° C. to 400° C., preferably between 150° C. and 250° C.

The present invention is to provide a titanium dioxide photocatalyst containing platinum oxide which is prepared according to the method described above, wherein the titanium dioxide photocatalyst containing platinum oxide exhibits photocatalytic activity under ultraviolet light irradiation (wavelength <400 nm) and visible light irradiation (wavelength range from 400 nm to 700 nm).

The photocatalyst prepared according to the present invention exhibits photocatalytic activity under visible light and its process is simple and feasible. It can enhance the use efficiency of solar energy and enlarge the application of photocatalyst.

### BRIEF DESCRIPTION OF THE DRAWINGS

FIG. 1 shows the flow chart for preparing titanium dioxide photocatalyst.

FIG. 2 shows the flow chart for preparing titanium dioxide photocatalyst loaded with platinum oxide.

FIG. 3 shows the flow chart for modifying titanium dioxide photocatalyst with platinum oxide.

FIG. 4 shows the XRD graphs of various titanium dioxide photocatalysts.

FIG. 5 shows the absorption spectrographs of various titanium dioxide photocatalysts.

FIG. 6 is the TEM photo of titanium dioxide photocatalyst in Example 1.

FIG. 7 is the TEM photo of titanium dioxide photocatalyst in Example 2.

FIG. 8 is the Carbon 1s XPS graph of titanium dioxide photocatalyst in Example 1 and 4.

FIG. 9 is the Platinum 4f XPS graph of titanium dioxide photocatalyst in Example 3 and 4.

FIG. 10 shows the photocatalytic activity test chart of titanium dioxide photocatalyst in Example 4 under visible light (loading ratio of Pt:Ti was 1:100).

FIG. 11 shows the absorption spectrographs of titanium dioxide photocatalysts under different calcination temperature.

### DETAILED DESCRIPTION OF THE INVENTION

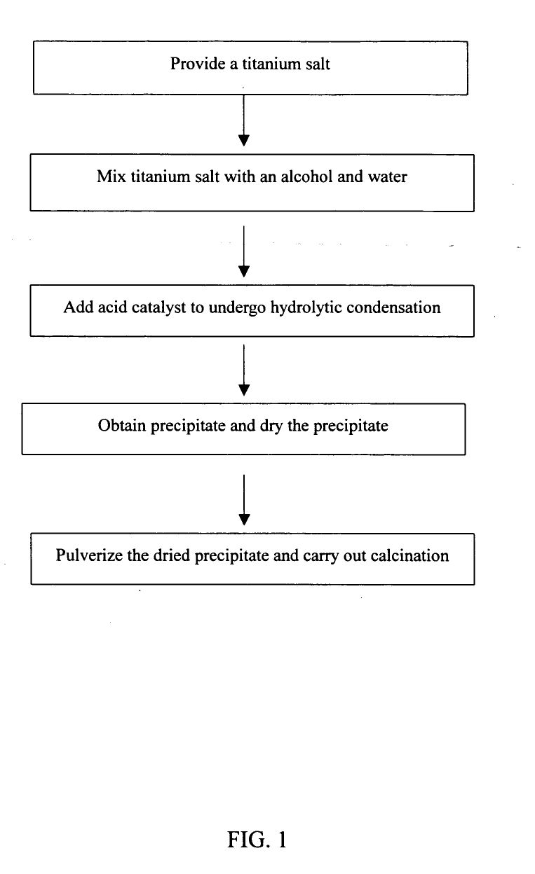

The method for preparing visible-light-activated titanium dioxide photocatalyst according to the present invention as shown in FIG. 1 comprises the steps of: (1) providing a titanium salt, such as alkyl titanate compound having a structural formula of Ti(OR)₄, where R=CₙH₂ₙ₊₂, n=2˜15. Commonly seen titanium salt includes, but not limited to, tetra(n-butoxyl) titanium, tetra(n-propoxyl) titanium and tetra(isopropoxyl) titanium; (2) mixing the titanium salt with an alcohol and water into aqueous solution of alcohol containing titanium salt. Commonly used alcohol includes, but not limited to methanol, ethanol, propanol and isopropanol. The temperature during mixing is between −10° C. and 40° C. and mixing continues until the solution becomes clear; (3) adding an acid catalyst into the aqueous solution and mixing the reactants (the volume ratio of the reactants is acid catalyst:aqueous solution of alcohol=1:100 to 1:10). Commonly used acid catalyst includes, but not limited to, nitric acid, hydrochloric acid, acetic acid, and oxalic acid. The solution added with acid catalyst begins hydrolytic condensation with temperature kept at 20° C. to 80° C. during the reaction and the reaction time lasts from 1 to 6 hours. After the reaction, white precipitate of titanium hydroxide is obtained; (4) drying the precipitate under temperature of 50° C. to 150° C. for 1 to 4 hours to remove the moisture in the precipitate; and (5) pulverizing the dried titanium hydroxide into powder and then carrying out calcination under the temperature of 150° C. to 400° C. for 2 to 24 hours to obtain titanium dioxide photocatalyst. The titanium dioxide photocatalyst prepared according to the method described above exhibit photocatalytic activity under both ultraviolet light and visible light, and is in a mixed anatase-brookite phase with grain size ranging from 5 to 20 nm.

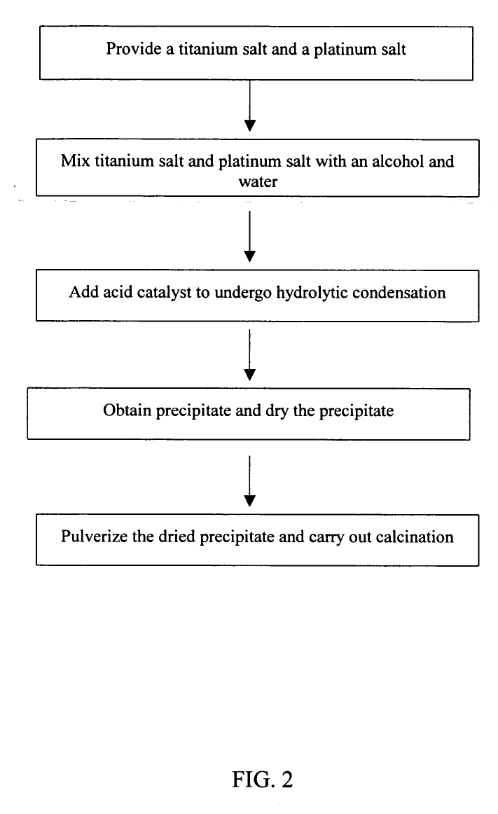

Another method for preparing visible-light-activated titanium dioxide photocatalyst according to the present invention as shown in FIG. 2 comprises the steps of: (1) providing a titanium salt and a platinum salt, wherein the titanium salt is an alkyl titanate compound having a structural formula of Ti(OR)₄, where R=CₙH₂ₙ₊₂, n=2˜15, including, but not limited to, tetra(n-butoxyl) titanium, tetra(n-propoxyl) titanium, and tetra(isopropoxyl) titanium, whereas the platinum salt includes, but not limited to, platinum nitrate, platinum nitrite, platinum ammonium nitrate, platinum ammonium sulfate or platinum acetate. The platinum salt is added by the weight of element titanium to element platinum in the ratio of 5000 to 100; (2) mixing the titanium salt and platinum salt with an alcohol and water into aqueous solution of alcohol containing titanium salt and platinum salt. Commonly used alcohol includes, but not limited to, methanol, ethanol, propanol or isopropanol. The temperature during mixing is between −10° C. and 40° C. and mixing continues until the solution becomes clear; (3) adding an acid catalyst into the aqueous solution and mixing to undergo hydrolytic condensation (the volume ratio of the reactants is acid catalyst:aqueous solution of alcohol=1:100 to 1:10) under the temperature of 20° C. to 80° C. for 1 to 6 hours. After the reaction, light yellow precipitate of platinum-containing titanium hydroxide is obtained; (4) drying the precipitate under temperature of 50° C. to 150° C. for 1 to 4 hours to remove the moisture in the precipitate; and (5) pulverizing the dried titanium hydroxide into powder and then carrying out calcination under the temperature of 150° C. to 400° C. for 2 to 24 hours to obtain platinum oxide-containing titanium dioxide photocatalyst. The platinum oxide-containing titanium dioxide photocatalyst prepared according to the method described above exhibit photocatalytic activity under both ultraviolet light and visible light, and has anatase phase with grain size ranging from 5 to 20 nm.

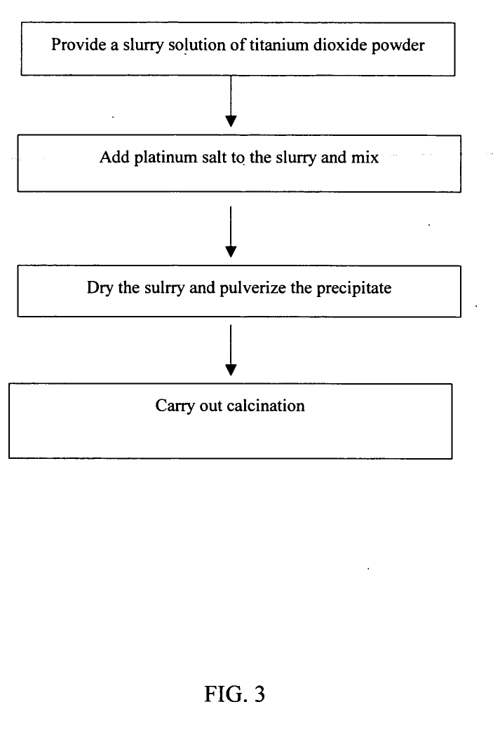

Yet another method for preparing visible-light-activated titanium dioxide photocatalyst containing platinum oxide according to the present invention as shown in FIG. 3 comprises the steps of: (1) providing slurry solution of titanium dioxide powder having a concentration of 1-30% which is obtained on the market or prepared according to the method described herein (not containing platinum oxide); (2) adding platinum salt to the slurry solution by the weight of element titanium to element platinum in the ratio of 5000 to 100 and then mixing to undergo dissolution under the temperature of 10° C. to 90° C. for 1 to 4 hours; (3) filtering and then drying the slurry solution to remove moisture under the temperature of 50° C. to 150° C. for 1 to 4 hours to obtain light yellow platinum oxide-containing titanium dioxide; and (4) pulverizing the light yellow substance into powder and then undergoing calcinations under the temperature of 150° C. to 400° C. for 2 to 24 hours to obtain titanium dioxide photocatalyst containing platinum oxide.

The platinum oxide-containing titanium dioxide photocatalyst prepared according to the method described above exhibit photocatalytic activity under both ultraviolet light and visible light, and its crystalline phase and grain size do not change in this method.

The present invention is further depicted in the illustration of examples, but the descriptions made in the examples should not be construed as a limitation on the actual application of the present invention.

### EXAMPLE 1

### Preparation of Visible-Light-Activated Titanium Dioxide Photocatalyst

Take 0.05 mole of tetra(n-butoxyl) titanium and slowly pipette it into 4° C., 70 ml anhydrous alcohol to prepare clear tetra(n-butoxyl) titanium ethanol solution. Take 20 ml of DI water and add it into 20 ml anhydrous alcohol to make ethanol aqueous solution. Mix the tetra(n-butoxyl) titanium ethanol solution and the ethanol aqueous solution for 1 hour and then add in 4 ml of nitric acid (70%) as acid catalyst. Mix the reactants to undergo hydrolytic condensation for 3 hours. Put the resulting precipitate into an oven to dry under 110° C. for 2 hours. Pulverize the dried precipitate into powder. Finally calcine the powder by progressively raising the temperature at the rate of 1° C./min up to 300° C. and maintaining at that temperature for 10 hours.

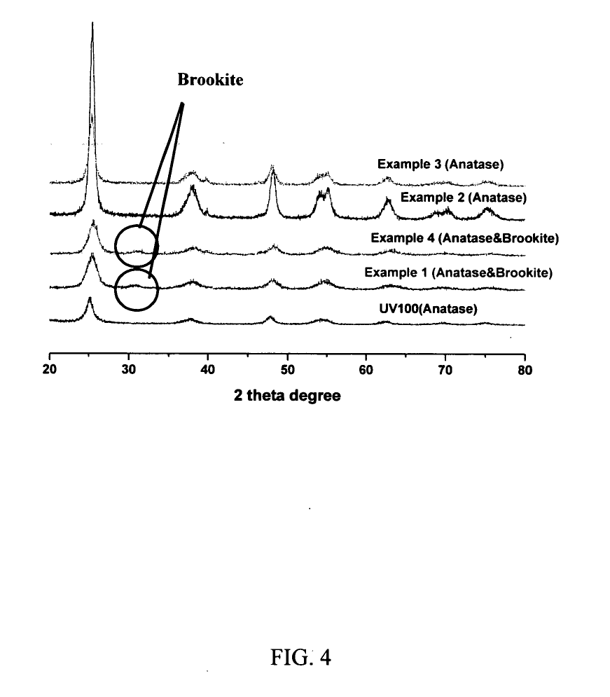

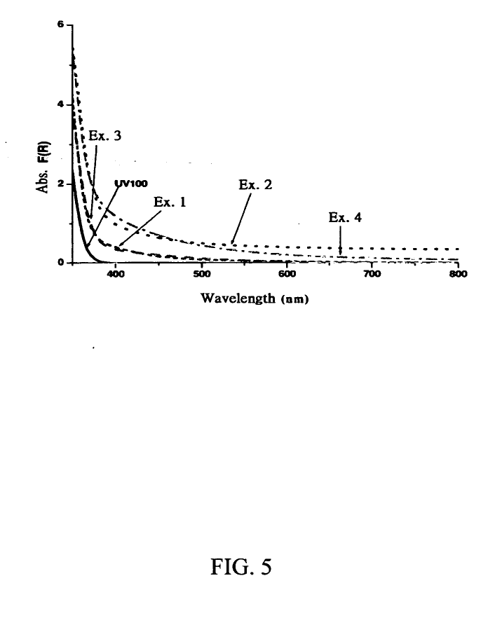

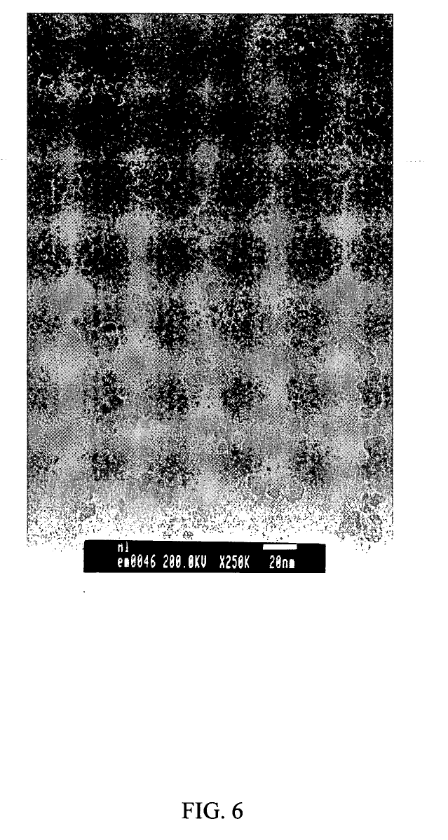

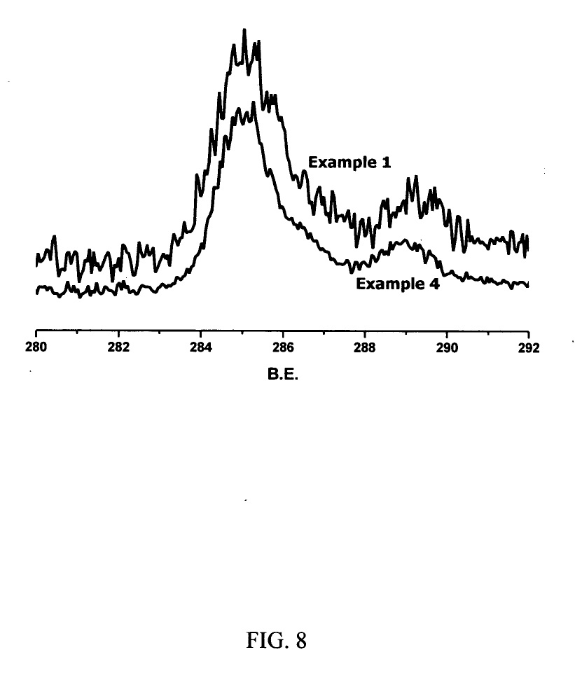

The crystalline pattern of the resulting titanium dioxide photocatalyst as shown by XRD graph in FIG. 4 is mixed anatase-brookite phase. Its absorbance data measured with absorption spectrograph are as shown in FIG. 5. Its grain size as shown by the TEM photo in FIG. 6 ranges from 5 to 20 nm. There are two reasons why the titanium dioxide photocatalyst produced in the process exhibits light absorption in visible light range: the presence of carbon atom in its structure as measured by XPS in FIG. 8 which causes the structural defect of titanium dioxide, and its mixed phase of anatase and brookite.

### EXAMPLE 2

### Preparation of Visible-Light-Activated Titanium Dioxide Photocatalyst Containing Platinum Oxide

Take 0.1 mole of tetra(n-butoxyl) titanium and slowly pipette it into 140 ml anhydrous alcohol to prepare clear tetra(n-butoxyl) titanium ethanol solution. Take 40 ml of DI water and add it into 40 ml anhydrous alcohol to make ethanol aqueous solution. Take platinum ammonium nitrate in an amount according to the desired loading and add it into the aforesaid ethanol aqueous solution. Mix the tetra(n-butoxyl) titanium ethanol solution and the platinum-containing ethanol aqueous solution for 1 hour and then add in 8 ml of nitric acid (70%) as acid catalyst. Mix the reactants to undergo hydrolytic condensation for 3 hours. Put the resulting precipitate into an oven to dry under 110° C. Pulverize the dried precipitate into powder. Finally calcine the powder by progressively raising the temperature at the rate of 1° C./min up to 300° C. and maintaining at that temperature for 10 hours.

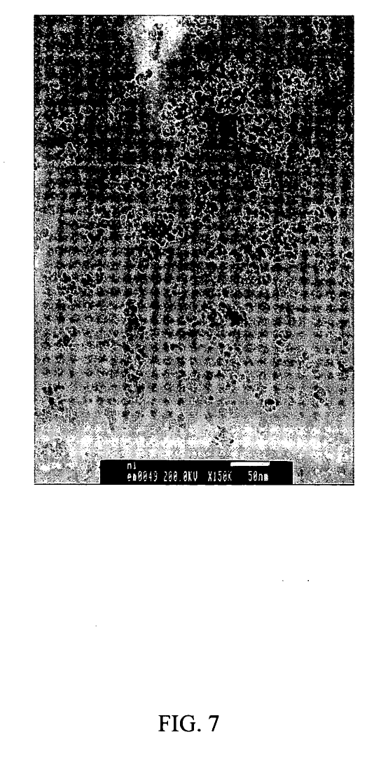

The resulting titanium dioxide photocatalyst contains 1% platinum (Pt/Ti). Its crystalline pattern as shown by XRD in FIG. 4 is anatase phase due to the addition of platinum salt. Its grain size as shown by the TEM photo in FIG. 7 ranges from 5 to 20 nm. Its absorbance data measured with absorption spectrograph are as shown in FIG. 5. There are two reasons why the titanium dioxide photocatalyst produced in the aforesaid process exhibits light absorption in visible light range: the presence of carbon atom in its structure which causes the structural defect of titanium dioxide, and the content of platinum oxide in its lattice; as the loading of platinum oxide increases, the ability of visible light absorption of the titanium dioxide photocatalyst increases. The XPS indicates the presence of carbon and platinum oxide on the surface of the photocatalyst.

### EXAMPLE 3

### Preparing Visible-Light-Activated Titanium Dioxide Photocatalyst Containing Platinum Oxide with Commercial Titanium Dioxide

Prepare platinum salt solution according to the desired loading by dissolving (Pt(NH₄)₄(NO₃)₂) in 100 ml of pure water. Place 10 g of titanium dioxide powder bought on the market (UV100) in the platinum-containing aqueous solution and mix for 30 minutes. Dry the solution under 110° C. Pulverize the resulting lump and then calcine the powder by progressively raising the temperature at the rate of 1° C./min up to 300° C. and maintaining at that temperature for 10 hours.

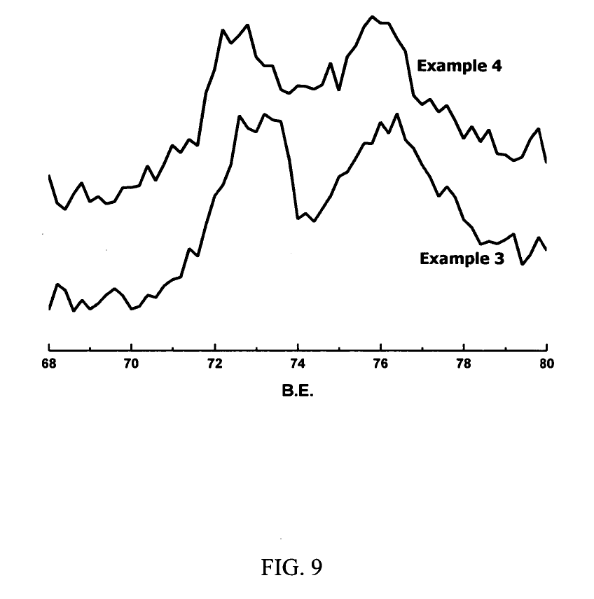

The resulting titanium dioxide photocatalyst contains 1% platinum (Pt/Ti). Its crystalline pattern as shown in FIG. 4 is anatase, the same as UV100. Its absorption spectrograph is as shown in FIG. 5, indicating the modified photocatalyst absorbs visible light where the absorption effect gets enhanced as the loading of platinum increases. The light absorption ability of the photocatalyst comes from the interaction between the loaded platinum oxide and titanium dioxide. The XPS in FIG. 9 indicates the presence of platinum oxide on the surface of the photocatalyst.

### EXAMPLE 4

### Preparing Visible-Light-Activated Titanium Dioxide Photocatalyst Containing Platinum Oxide with Titanium Dioxide Photocatalyst Produced in Example 1

Dissolve proper amount of (Pt(NH₄)₄(NO₃)₂) in 100 ml of pure water. Place 10 g of titanium dioxide powder from Example 1 in the platinum-containing aqueous solution and mix for 30 minutes. Dry the solution under 110° C. Pulverize the resulting lump and then calcine the powder by progressively raising the temperature at the rate of 1° C./min up to 300° C. and maintaining at that temperature for 10 hours.

The resulting titanium dioxide photocatalyst contains 1% platinum (Pt/Ti). Its crystalline pattern as shown in FIG. 4 is mixed anatase-brookite phase, the same as the product derived in Example 1. The XRD graph does not show marked peak of platinum oxide. There are two reasons for this phenomenon: (1) the amount of platinum oxide loaded is small; and (2) the grain size of loaded platinum oxide is small, which has indistinct peak. Its absorption spectrograph is as shown in FIG. 5, indicating the effect of visible light absorption the absorption effect gets stronger as the loading of platinum increases. The titanium dioxide photocatalyst prepared in Example 1 comes with the ability of visible light absorption. Its efficiency of visible light absorption is significantly enhanced after the loading of titanium oxide, which in turn enhances the use of solar energy. The XPS in FIGS. 8 and 9 indicates the presence of carbon and platinum oxide on the surface of the photocatalyst.

### EXAMPLE 5

### Testing the NO Degradation Activity of TiO₂ in Example 4 Under Visible Light

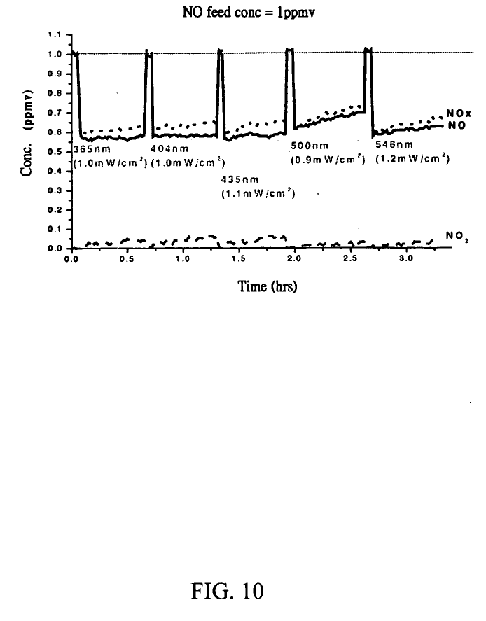

In this example, the catalytic activity of TiO₂ on nitrogen oxide is tested. The pollutant treatment standard is set at 1 ppmᵥ NO, and JIS R 1701-1 test method is followed with regard to the NOx degradation system. Mercury lamp filtered by 365 nm, 404 nm, 435 nm, 500 nm and 546 nm lens to obtain narrow light range provide the sources of light excitation. Red LED lamp is used to provide 600-700 nm of light. As such, data obtained will not be influenced by light of other wavelengths. Data on the photocatalytic activity of TiO₂ under visible light are depicted in FIG. 10. As shown, the modified photocatalyst has catalytic activity under wavelength 365 nm to 546 nm. According to Table 1, unmodified UV100 photocatalyst does not possess photocatalytic activity in the range of 500 nm to 546 nm. It is also found that the modified photocatalyst not only shows catalytic activity under visible light, it also has enhanced selectivity towards NO. As the loading of platinum increases, the generation of intermediate product NO₂ decreases, hence improving the NOx removal rate of photocatalyst under the wavelengths of 365 nm, 404 nm, and 435 nm. The photocatalyst still shows activity under 500 nm and 546 nm. In addition, as the loading of platinum oxide increases, the generation of harmful intermediate product NO₂ decreases, hence enhancing the effect of NOx removal. The titanium dioxide photocatalyst derived in Example 4 herein possesses good catalytic activity under visible light with the intensity of light source at around 1 mW/cm². Its NO conversion rate is around 0.55 under the irradiation of light having wavelength from 365 nm to 546 nm, and its activity remains the same as wavelength increases, suggesting excellent photocatalytic activity under visible light.

### COMPARATIVE EXAMPLE 1

### Preparing Platinum-Containing Titanium Dioxide Photocatalyst with Photoelectrodeposition Method

To compare the photocatalytic activity of titanium dioxide photocatalyst under visible light prepared according to the present invention and that prepared according to prior art, the present invention also prepares platinum-containing titanium dioxide photocatalyst using the photoelectrodeposition method in the prior art. Photoelectrodeposition is a commonly mentioned method for photocatalyst modification. For example, Taizo Sano et al. mention in their paper published in Journal of Molecular Catalysis A: Chemical in 2002 that after P25 has been modified with photoelectrodeposition, the generation of phosgene, a toxic intermediate product in the degradation of vinyl chloride is reduced. In their process, the powder surface was not loaded with platinum oxide, but element platinum. The steps for preparing titanium dioxide photocatalyst with photoelectrodeposition are as follows: Prepare platinum salt solution according to the desired loading (Pi/Ti=1/100) by dissolving (Pt(NH₄)₄(NO₃)₂) in 100 ml of pure water and 100 mL of ethanol, and mixing well. Place 10 g of titanium dioxide powder bought on the market (UV100) in the aforesaid solution and mix for 30 minutes. Adjust pH with 0.1N KOH to 6.8, and then irradiate the solution with 300 W mercury lamp for 5 hours. Rinse with D.I. water several times and centrifuge the solution to separate the precipitate. Dry the precipitate under 100° C. for 12 hours to obtain titanium dioxide photocatalyst containing element platinum.

### COMPARATIVE EXAMPLE 2

### Preparing Platinum-Containing Titanium Dioxide Photocatalyst with Hydrogen Reduction Method

To confirm the effect of oxidation state platinum on the photocatalytic activity of titanium dioxide photocatalyst under visible light prepared according to the present invention, the present invention also prepares platinum-containing titanium dioxide photocatalyst using the hydrogen reduction method in the present invention. Hydrogen reduction is a commonly mentioned method for thermalcatalyst modification. The steps for preparing titanium dioxide photocatalyst with hydrogen reduction are as follows: Put 5 g of produced photocatalyst in Example 4 in to a quartz tube and heating at 200° C. at hydrogen atmosphere for 3 hours. The flow rate of hydrogen is controlled at 50 mL/min. Pulverize the precipitate to obtain titanium dioxide photocatalyst containing element platinum. In this process, the platinum oxide on the TiO₂ surface is converted to element platinum by hydrogen.

### COMPARATIVE EXAMPLE 3

### Preparing Titanium Dioxide Photocatalyst with Platinum Chloride

To compare the photocatalytic activity of titanium dioxide photocatalyst under visible light prepared according to the present invention and that prepared according to prior art, the present invention also prepares platinum-containing titanium dioxide photocatalyst using the impregnation method in the prior art. Impregnation is a commonly mentioned method for catalyst modification. For example, Horst Kisch et al. presented in the CHEMPHYSCHEM in 2002, a method of depositing PtCl₄, AuCl₂, and RuCl₃ either in the bulk or only on the surface of photocatalyst to enhance the visible-light-photocatalysis of 4-chlorophenol in an aqueous phase. In their process, the powder surface was not loaded with N-contained platinum salt, but platinum chloride. The steps for preparing titanium dioxide photocatalyst with platinum chloride are as follows: Dissolve proper amount of PtCl₄ in 100 ml of 0.1N hydrogen chloride water. Place 10 g of titanium dioxide powder bought on the market (UV100) in the platinum-containing aqueous solution and mix for 30 minutes. Dry the solution under 110° C. Pulverize the resulting lump and then calcine the powder by progressively raising the temperature at the rate of 1° C./min up to 300° C. and maintaining at that temperature for 10 hours to obtain the PtCl₄-contained titanium dioxide.

### EXAMPLE 6

### Comparing the NO Degradation Activity of Commercial TiO₂ Photocatalyst and Visible-Light-Activated Photocatalyst of the Present Invention Under Visible Light

The titanium dioxide photocatalyst of the present invention is compared with Hombikat UV100, Degussa P25, Ishihara ST01 and ST21. The photocatalytic activity under visible light is tested using the same method as that in Example 5. It is found that the activity of commercial photocatalysts is inferior to that of the photocatalysts of the present invention under long-wavelengths, but shows no significant difference under short-wavelengths. As shown in Table 1, in the UV light range from 365 nm to 404 nm, the effect of commercial titanium dioxide powders on nitrogen monoxide degradation shows no significant difference from that of titanium dioxide photocatalysts prepared in Examples 1-4 herein. But under the irradiation of light with 435 nm wavelength, the effect of titanium dioxide photocatalysts prepared in Examples 1-4 is 50-60% better than that of commercial powders and Comparative Examples. Under 500 nm and 546 nm, the contrast is even more prominent with the photocatalysts of the present invention exhibiting 10 times stronger effect than commercial photocatalysts. The product derived in Example 4 shows the same photocatalytic activity under 546 nm as that under UV light irradiation (365 nm), and still retains activity under the irradiation of red LED (600-700 nm). From the absorption spectrograph in FIG. 5, it is seen that the titanium dioxide photocatalysts prepared according to the present invention absorb both visible light and UV light. The commercial catalysts do not exhibit light absorption under wavelength higher than 380 nm, while titanium dioxide powders prepared according to the present invention show distinct absorption under the wavelengths of 350-700 nm. The testing of platinum-containing titanium dioxide photocatalyst prepared by photoelectrodeposition as described in Comparative Example 1 shows that its photocatalytic activity is greater than that of UV 100, but it does not show obvious activity under visible light. Comparative Example 2 and 3 show that their photocatalytic activities are both greater than that of UV 100, but both of them do not show obvious activity under visible light. The less visible-light-activity of Comparative Example 2 and 3 is due to the platinum oxide on the TiO₂ surface is reduced to elementary platinum. The result of Comparative Example 3 depicts that only N-contained platinum salt added in the sol-gel or impregnation processes will improve the visible-light-activity of TiO₂. The photocatalyst of the present invention have platinum oxide and carbon on its surface and absorb visible light effectively. Its performance is much superior to that of commercial photocatalysts. Since visible light accounts for a much wider region in the light spectrum than UV light, the photocatalysts of the present invention can absorb solar energy more effectively and convert it to chemical energy in actual applications.

TABLE 1
Nitrogen Oxide Removal Effect of Commercial
Titanium Dioxide Powders and Titanium Dioxide
Photocatalysts of the Present Invention

| Titanium dioxide | Wavelength (nm) | | | | | |
|---|---|---|---|---|---|---|
| powder | 365 | 404 | 435 | 500 | 546 | 600-700 |
| UV 100 | 37% | 33% | 25% | 1% | 2% | 0% |
| P25 | 37% | 38% | 22% | 1% | 1% | 0% |
| ST01 | 39% | 35% | 25% | 4% | 3% | 0% |
| ST21 | 39% | 34% | 23% | 3% | 2% | 0% |
| Example 1 | 43% | 36% | 35% | 25% | 21% | 17% |
| Example 2 | 38% | 36% | 35% | 19% | 19% | 15% |
| Example 3 | 44% | 40% | 35% | 25% | 32% | 25% |
| Example 4 | 39% | 39% | 38% | 36% | 40% | 33% |
| Comp. Example 1 | 40% | 35% | 28% | 3% | 2% | 0% |
| Comp. Example 2 | 39% | 35% | 26% | 5% | 2% | 0% |
| Comp. Example 3 | 41% | 32% | 25% | 2% | 2% | 0% |

(Feed conc. of nitrogen monoxide: 1 ppmᵥ; flow rate: 1 L/min; RH: 50%, powder weight: 0.5 g; illuminance: 1 mW/cm², removal rate: %)

### EXAMPLE 7

### The Effect of Calcination Temperature on the NO Degradation Activity of Photocatalyst Under Visible Light

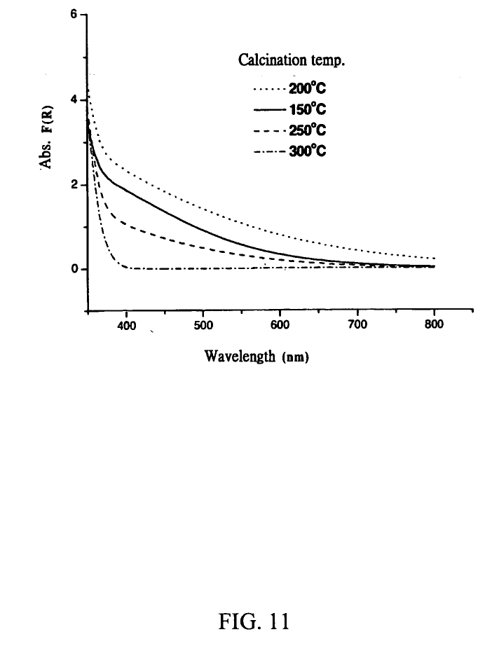

The steps of synthesizing visible-light-activated photocatalyst in this example are the same as those in Example 1, but the calcination temperature is 150° C., 200° C., 250° C., and 300° C. (for 10 hours) respectively. The photocatalysts obtained under different calcination temperatures are tested for photocatalytic activity under 546 nm. The test procedure is the same as that in Example 5, and the results are depicted in Table 2. As shown, at 200° C. calcinations temperature, the photocatalyst exhibits the greatest photocatalytic activity under 546 nm and its NOx removal rate reaches 60%. Photocatalyst produced at 300° C. calcinations temperature has only 23% NOx removal rate. The reason for such disparity is because high calcinations temperature would cause the change of surface structure and increase in grain size, thereby reducing the activity. The absorption spectrograph (FIG. 11) also shows the same trends. Above 400 nm, the intensity of visible light absorption is in sequence 200° C.>150° C.>250° C.>300° C., which is consistent with the trends of photocatalytic activity. According to the test results, photocatalyst produced at calcination temperature of 200° C. shows the highest utilization of visible light energy and best meets the demands of sunlight-grade photocatalyst in practical applications.

TABLE 2
Effect of Calcination Temperature on the NO Removal
Activity of Photocatalysts in Example 7

Calcination temp.

| Effect | 150° C. | 200° C. | 250° C. | 300° C. |
|---|---|---|---|---|
| NO residual rate | 35% | 17% | 15% | 39% |
| NO₂ residual rate | 15% | 23% | 50% | 44% |
| NOx removal rate | 50% | 60% | 35% | 23% |

(Feed conc. of nitrogen monoxide: 1 ppmᵥ; flow rate: 1 L/min; RH: 50%, powder weight: 0.5 g; wavelength and illuminance: 546 nm, 1 mW/cm², removal rate and residual rate: %)

To sum up, the titanium dioxide photocatalyst of the present invention possesses photocatalytic activity under visible light range. When it is loaded with platinum oxide on the surface, its photocatalytic activity under visible light is more pronounced. The visible-light-activated titanium dioxide photocatalyst of the present invention is prepared by controlling the process condition by controlling the calcinations temperature between 150° C. and 400° C., preferably between 150° C. and 250° C. The crystalline pattern and grain size of the titanium dioxide photocatalyst herein enhance its photocatalytic activity under visible light.

### Other Embodiments

The preferred embodiments of the present invention have been disclosed in the examples. However the examples should not be construed as a limitation on the actual applicable scope of the invention, and as such, all modifications and alterations without departing from the spirits of the invention and appended claims, including the other embodiments shall remain within the protected scope and claims of the invention.

1. A method for preparing visible-light-activated titanium dioxide photocatalyst, comprising the steps of:
providing a titanium salt;
mixing said titanium salt with an alcohol and water to prepare aqueous solution of alcohol containing titanium salt;
adding an acid catalyst into said aqueous solution of alcohol to react and obtain a precipitate;
drying said precipitate; and
pulverizing and calcining said dried precipitate; wherein the calcination temperature ranges from 150° C. to 400° C.

2. The method according to claim 1, wherein said titanium salt is alkyl titanate having a structural formula of Ti(OR)₄, where R is —CₙH₂ₙ₊₁, n=2˜15.

3. The method according to claim 1, wherein said alcohol is methanol, ethanol, isopropanol or propanol.

4. The method according to claim 1, wherein the volume ratio of alcoohol to water in said aqueous solution of alcohol is 3:1 to 1:3.

5. The method according to claim 1, wherein said acid catalyst is nitric acid, hydrochloric acid, acetic acid or oxalic acid.

6. The method according to claim 1 wherein the volume ratio of said acid catalyst to aqueous solution of alcohol is 1:100 to 1:10.

7. The method according to claim 1, wherein the calcinations temperature ranges from 150° C. to 250° C.

8. A titanium dioxide photocatalyst having mixed anatase-brookite phase with grain size ranging from 5 nm to 20 nm, characterized in which it exhibits photocatalytic activity under ultraviolet light irradiation (wavelength <400 nm) and visible light irradiation (wavelength range from 400 nm to 700 nm).

9. The titanium dioxide photocatalyst according to claim 8, which is prepared by the method comprising the steps of:
providing a titanium salt;
mixing said titanium salt with an alcohol and water to prepare aqueous solution of alcohol containing titanium salt;
adding an acid catalyst into said aqueous solution of alcohol to react and obtain a precipitate; and
drying said precipitate; and
pulverizing and calcining said dried precipitate; wherein the calcination temperature ranges from 150° C. to 400° C.

10. A method for preparing visible-light-activated titanium dioxide photocatalyst, comprising the steps of:
providing a titanium salt and a platinum salt;
mixing said titanium salt and platinum salt with an alcohol and water into aqueous solution of alcohol containing titanium salt and platinum salt;
adding an acid catalyst into said aqueous solution of alcohol to react and obtain a precipitate;
drying said precipitate; and
pulverizing and calcining said dried precipitate; wherein the calcination temperature ranges from 150° C. to 400° C.

11. The method according to claim 10, wherein said titanium salt is alkyl titanate having a structural formua of of Ti(OR)₄, where R is —CₙH₂ₙ₊₁, n=2˜15.

12. The method according to claim 11, wherein said platinum salt is platinum nitrate, platinum nitrite platinum ammonium nitrate, platinum ammonium sulfate or platinum acetate.

13. The method according to claim 10, wherein said alcohol is methanol, ethanol, isopropanol or propanol.

14. The method according to claim 10, wherein the volume ratio of alcoohol to water in said aqueous solution of alcohol is 3:1 to 1:3.

15. The method according to claim 10, wherein the weight of element titanium to element platinum in the titanium salt and platinum salt contained in said aqueous solution of alcohol is in the ratio of 5000 to 100.

16. The method according to claim 10, wherein said acid catalyst is nitric acid, hydrochloric acid, acetic acid or oxalic acid.

17. The method according to claim 10, wherein the volume ratio of said acid catalyst to aqueous solution of alcohol is 1:100 to 1:10.

18. The method according to claim 10, wherein the calcinations temperature ranges from 150° C. to 250° C.

19. A titanium dioxide photocatalyst that contains platinum oxide and has anatase phase with grain size ranging from 5 nm to 20 nm, characterized in which it exhibits photocatalytic activity under ultraviolet light irradiation (wavelength <400 nm) and visible light irradiation (wavelength range from 400 nm to 700 nm).

20. The titanium dioxide photocatalyst according to claim 19, which is prepared by the method comprising the steps of:
providing a titanium salt and a platinum salt;
mixing said titanium salt and platinum salt with an alcohol and water into aqueous solution of alcohol containing titanium salt and platinum salt;
adding an acid catalyst into said aqueous solution of alcohol to react and obtain a precipitate;
drying said precipitate; and
pulverizing and calcining said dried precipitate; wherein the calcination temperature ranges from 150° C. to 400° C.

21. A method for preparing visible-light-activated titanium dioxide photocatalyst, comprising the steps of:
providing a nanosized titanium dioxide photocatalyst;
adding said titanium dioxide photocatalyst into the aqueous solution of platinum salt and mixing;
drying said platinum salt solution; and
pulverizing and calcining said dried precipitate; wherein the calcination temperature ranges from 150° C. to 400° C.

22. The method according to claim 21, wherein said platinum salt is platinum nitrate, platinum nitrite platinum ammonium nitrate, platinum ammonium sulfate or platinum acetate.

23. The method according to claim 21, wherein the weight of element titanium to element platinum in the titanium salt and platinum salt contained in said aqueous solution of alcohol is in the ratio of 5000 to 100.

24. The method according to claim 21, wherein the calcinations temperature ranges from 150° C. to 250° C.

25. A kind of platinum oxide-containing titanium dioxide photocatalyst prepared according to the method of claim 21, characterized in which said platinum oxide-containing titanium dioxide photocatalyst exhibits photocatalytic activity under ultraviolet light irradiation (wavelength <400 nm) and visible light irradiation (wavelength range from 400 nm to 700 nm).
